(19) United States
(12) Patent Application Publication
(10) Pub. No.: US 2020/0106088 A1
(43) Pub. Date: Apr. 2, 2020

(54) ALL SOLID BATTERY

(71) Applicant: TAIYO YUDEN CO., LTD., Tokyo (JP)

(72) Inventors: Daigo ITO, Takasaki-shi (JP); Takato SATOH, Takasaki-shi (JP); Sachie TOMIZAWA, Takasaki-shi (JP); Chie KAWAMURA, Takasaki-shi (JP)

(21) Appl. No.: 16/572,353

(22) Filed: Sep. 16, 2019

(30) Foreign Application Priority Data
Sep. 27, 2018 (JP) 2018-182879

(51) Int. Cl. H01M 4/131; H01M 10/0525; H01M 4/525; H01M 10/0562

(52) U.S. Cl. CPC H01M 4/131; H01M 10/0562; H01M 4/525; H01M 10/0525

(57) ABSTRACT

An all solid battery includes: a first electrode layer that includes a positive electrode active material and a Li—La—Ti—O-based oxide; a second electrode layer that includes a positive electrode active material and a Li—La—Ti—O-based oxide; and a solid electrolyte layer that includes an oxide-based solid electrolyte and is sandwiched by the first electrode layer and the second electrode layer.

### CROSS-REFERENCE TO RELATED APPLICATION

This application is based upon and claims the benefit of priority of the prior Japanese Patent Application No. 2018-182879, filed on Sep. 27, 2018, the entire contents of which are incorporated herein by reference.

### FIELD

A certain aspect of the present invention relates to an all solid battery.

### BACKGROUND

There is disclosed a technology in which a thickness of each layer of an all solid lithium ion secondary battery is reduced and a large number of layers are stacked, in order to improve response and capacity density. For example, there is disclosed a manufacturing method of an all solid battery having a multilayer structure (for example, see Japanese Patent Application Publication No. 2008-198492 hereinafter referred to as Document 1). It is possible to increase energy density of an all solid battery having a multilayer structure. When the all solid battery has the multilayer structure, electric collector layers of positive electrode layers and electric collector layers of negative electrode layers are separately extracted and are connected to different external electrodes. However, in this case, it is necessary to distinguish between a positive external electrode and a negative external electrode. When the positive external electrode and the negative external electrode are incorrectly connected to terminals, the all solid battery does not correctly operate. Moreover, the all solid battery may be broken down.

And so, there is disclosed a symmetrical battery in which distinguishing between a positive electrode and a negative electrode is not needed (for example, see Japanese Patent Application Publication No. 2008-235260 and Electrochemistry Communications Volume 12, Issue 7, July 2010, Pages 894-896). In the symmetrical all solid battery, a positive electrode and a negative electrode have a common active material. The common active material have two different oxidation-reduction potentials. And, there is disclosed an all solid battery in which Ni—Co—Al based (NCA) positive electrode active material are provided on both electrodes sandwiching Li₇La₃Zr₂O₁₂ (LLZ) solid electrolyte (for example, see Japanese Patent Application Publication No. 2013-243112 hereinafter referred to as Document 3). Moreover, there is disclosed a technology in which, the multilayer structure is devised, a positive electrode layer and a negative electrode layer are stacked, an operation part fluctuates according to a direction of an applied voltage, and no-polarity is achieved (for example, see Japanese Patent Application Publication No. 2011-146202 hereinafter referred to as Document 4).

### SUMMARY OF THE INVENTION

In the symmetrical battery, an output voltage is fixed. A discharge-charge capacity is lower than a theoretical capacity. Therefore, there is a problem that increasing of energy density is difficult. In the methods of Document 1 and Document 4, the internal structure of the multilayer structure is devised. In this case, the manufacturing process is complicated. In Document 3, it is necessary to release lithium from active materials of both electrodes, after making the symmetrical all solid battery.

The present invention has a purpose of providing an all solid battery that can be easily manufactured and has an operation voltage which can be freely designed.

According to an aspect of the present invention, there is provided an all solid battery including: a first electrode layer that includes a positive electrode active material and a Li—La—Ti—O-based oxide; a second electrode layer that includes a positive electrode active material and a Li—La—Ti—O-based oxide; and a solid electrolyte layer that includes an oxide-based solid electrolyte and is sandwiched by the first electrode layer and the second electrode layer.

### BRIEF DESCRIPTION OF THE DRAWINGS

FIG. 1 illustrates a schematic cross section of an all solid battery;

FIG. 2 illustrates a schematic cross section of another all solid battery;

FIG. 3 illustrates a flowchart of a manufacturing method of an all solid battery;

FIG. 4 illustrates a stacking process;

FIG. 5 illustrates a cyclic voltammogram of an example 1 and an example 2; and

FIG. 6 illustrates a discharge-charge curve.

### DETAILED DESCRIPTION

A description will be given of an embodiment with reference to the accompanying drawings.

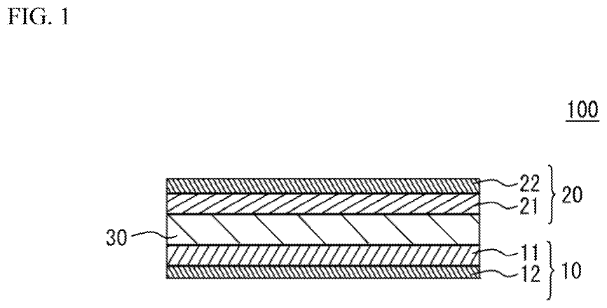

FIG. 1 illustrates a schematic cross section of an all solid battery 100. As illustrated in FIG. 1, the all solid battery 100 has a structure in which a first electrode 10 and a second electrode 20 sandwich a solid electrolyte layer 30. A main component of the solid electrolyte layer 30 is oxide-based solid electrolyte. The first electrode 10 is provided on a first main face of the solid electrolyte layer 30. The first electrode 10 has a structure in which a first electrode layer 11 and a first electric collector layer 12 are stacked. The first electrode layer 11 is on the solid electrolyte layer 30 side. The second electrode 20 is provided on a second main face of the solid electrolyte layer 30. The second electrode 20 has a structure in which a second electrode layer 21 and a second electric collector layer 22 are stacked. The second electrode layer 21 is on the solid electrolyte layer 30 side.

A main component of the solid electrolyte layer 30 is a phosphoric acid salt-based solid electrolyte achieving lithium ion conduction. For example, the phosphoric acid salt-based electrolyte has a NASICON structure. The phosphoric acid salt-based solid electrolyte having the NASICON structure has a high conductivity and is stable in normal atmosphere. The phosphoric acid salt-based solid electrolyte is, for example, such as a salt of phosphoric acid including lithium. The phosphoric acid salt is not limited. For example, the phosphoric acid salt is such as composite salt of phosphoric acid with Ti (for example LiTi₂(PO₄)₃). Alternatively, at least a part of Ti may be replaced with a transition metal of which a valence is four, such as Ge, Sn, Hf, or Zr. In order to increase an amount of Li, a part of Ti may be replaced with a transition metal of which a valence is three, such as Al, Ga, In, Y or La. In concrete, the phosphoric acid salt including lithium and having the NASICON structure is Li₁₊ₓAlₓGe₂₋ₓ(PO₄)₃, Li₁₊ₓAlₓZr₂₋ₓ(PO₄)₃, Li₁₊ₓAlₓTi₂₋ₓ(PO₄)₃ or the like. For example, it is preferable that Li—Al—Ge—PO₄-based material, to which a transition metal included in the phosphoric acid salt having the olivine type crystal structure included in the first electrode layer 11 and the second electrode layer 21 is added in advance, is used. For example, when the first electrode layer 11 and the second electrode layer 21 include phosphoric acid salt including Co and Li, it is preferable that the solid electrolyte layer 30 includes Li—Al—Ge—PO₄-based material to which Co is added in advance. In this case, it is possible to suppress solving of the transition metal included in the electrode active material into the electrolyte.

It is preferable that, in the solid electrolyte layer 30, a concentration of Ti with respect to all solid electrolyte is 10 wt. % or less. This is because growing of a negative electrode reaction site toward the positive electrode is suppressed and formation of a leak path is suppressed between the positive electrode and the negative electrode. It is more preferable that the solid electrolyte layer 30 includes a layer of the oxide-based solid electrolyte not including Ti. It is still more preferable that the solid electrolyte layer 30 is composed of the oxide-based solid electrolyte not including Ti. For example, it is preferable that the solid electrolyte layer 30 includes an oxide-based solid electrolyte layer not including Ti, between the positive electrode and the negative electrode. The oxide-based solid electrolyte not including Ti is such as Li—La—Zr—O-based oxide having a garnet structure, Li₄SiO₄—Li₃PO₄-based oxide, or Li—Al—Ge—P—O-based oxide. It is preferable that the Li—La—Zr—O-based oxide is such as Li₇La₃Zr₂O₁₂ of which a main crystal has a cubic phase, or Li₇La₃Zr₂O₁₂ of which a part is replaced by a metal element. For example, it is preferable that the Li—La—Zr—O-based oxide is such as Li₇₋ₓLa₃Zr₂₋ₓAₓO₁₂ (A: metal of which a valence is five), Li_{7-3y}La₃Zr₂B_{y}O₁₂ (B: metal of which a valence is three), Li_{7-x-3y}La₃Zr₂₋ₓAₓB_{y}O₁₂.

The first electrode layer 11 and the second electrode layer 21 have a structure in which an active material acting as a positive electrode (positive electrode active material) and an active material acting as a negative electrode (negative electrode active material) co-exist. The positive electrode active material is not limited. For example, the positive electrode active material is an active material having an olivine type crystal structure. The electrode active material is such as phosphoric acid salt including a transition metal and lithium. The olivine type crystal structure is a crystal of natural olivine. It is possible to identify the olivine type crystal structure, by using X-ray diffraction. The electrode active material having the olivine type crystal is such as an active material expressed by a formula LiMPO₄ (M=Mn, Fe, Co or Ni). For example, the electrode active material having the olivine type crystal is LiCoPO₄ including Co. The electrode active material having the olivine type crystal is such as a positive electrode active material having a laminar rock salt structure including at least on of Co, Mn and Ni, or a positive electrode active material having a spinel type structure expressed by a formula LiM₂O₄ (M=Mn, Ni).

Li—La—Ti—O compound (LLTO) which is a perovskite type solid electrolyte material may be used as the negative electrode active material. The LLTO also acts as an ion conduction auxiliary agent. The present inventors have found that the LLTO does not act in positive electrode operation. “The LLTO does not act in positive electrode operation” means that Li ions are not released and a valence of Ti does not change. The LLTO is favorable because the LLTO tends to have a perovskite structure of a high ion conduction phase when x is 0.04 to 0.14 in a lithium ion conductor expressed by La_{2/3-x}Li₃ₓTiO₃. It is preferable that a ratio of the LLTO in the first electrode layer 11 and the second electrode layer 21 is 20 vol. % or more from a viewpoint of achieving sufficient ion conduction and securing negative capacity by increasing an amount of the negative electrode active material to a predetermined value or more. It is more preferable that the ratio is 30 vol. % or more. It is preferable that the ratio of the LLTO in the first electrode layer 11 and the second electrode layer 21 is 80 vol. % or more from a viewpoint of securing capacity by increasing an amount of the positive electrode active material to a predetermined value or more. It is more preferable that the ratio is 70 vol. % or less. It is preferable that a thickness of the first electrode layer 11 and the second electrode layer 21 is 1 μm or more from a viewpoint of securing capacity of whole of the all solid battery 100. It is more preferable that the thickness is 2 μm or more. It is preferable that the thickness is 30 μm or less from a viewpoint of securing response. It is more preferable that the thickness is 10 μm or less.

Oxide-based solid electrolyte material and a conductive auxiliary agent such as carbon or metal may be added to the first electrode layer 11 and the second electrode layer 21, in addition to the active material. When the material is evenly dispersed into water or organic solution together with binder and plasticizer, paste for electrode layer is obtained. Pd, Ni, Cu, or Fe, or an alloy thereof may be used as a metal of the conductive auxiliary agent. When the first electrode layer 11 and the second electrode layer 21 have a thin thickness of a few μm, the first electrode layer 11 and the second electrode layer may not necessarily include the conductive auxiliary agent.

The first electric collector layer 12 and the second electric collector layer 22 are made of a conductive material.

In the embodiment, each of the first electrode layer 11 and the second electrode layer 21 includes the positive electrode active material and the LLTO. The positive electrode active material does not act in the negative electrode operation. The LLTO does not act in the positive electrode operation. Therefore, in an electrode layer connected to as a positive electrode, the negative electrode active material does not act and the positive electrode active material performs oxidation-reduction reaction. In an electrode layer connected to as a negative electrode, the positive electrode active material does not act and the LLTO performs oxidation-reduction reaction. Accordingly, the all solid battery 100 of the embodiment operates as a symmetrical battery.

In the embodiment, the positive electrode active material is not limited. It is possible to select the positive electrode active material from known active materials. It is therefore possible to freely design an operation voltage of the all solid battery 100.

When an active material acts as a positive electrode active material in one electrode and the active material acts as a negative electrode active material in the other electrode, an operation capacity of one of the electrodes is lower than that of the other. The active material of the other electrode can act only within the operation capacity difference. It is possible to use only the other active material corresponding to the capacity. It is not possible to use a theoretical capacity in one of the electrodes. However, in the embodiment, the LLTO in which an amount of Li corresponding to the theoretical capacity of the positive electrode active material can be inserted is provided. In this case, the discharge-charge capacity can get close to the theoretical capacity in both the positive electrode and the negative electrode. It is therefore possible to easily increase the energy density.

In the embodiment, the both electrodes include the positive electrode active material and the LLTO. Therefore, an internal structure of a multilayer structure may not necessarily have a complicated structure. Accordingly, it is possible to easily manufacture the multilayer structure.

It is possible to use the first electrode layer 11 and the second electrode layer 21 as both of the positive electrode and the negative electrode. It is therefore not necessary to distinguish between the positive electrode and the negative electrode during the manufacturing. It is possible to reduce defective lots caused by human error. It is not necessary to distinguish between the positive electrode and the negative electrode after the manufacturing. Therefore. cost can be reduced. When the all solid battery 100 is used as a battery, it is not necessary worry about polarity. Therefore, trouble can be suppressed and cost can be reduced, in a process such as mounting. It is possible to switch the positive electrode and the negative electrode during the usage of the all solid battery 100. It is therefore possible to enlarge a range of design of usage.

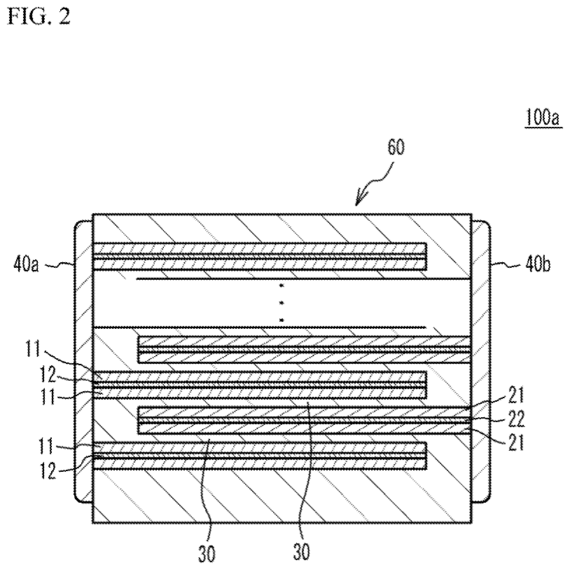

FIG. 2 illustrates a schematic cross section of an all solid battery 100a in accordance with another embodiment. The all solid battery 100a has a multilayer chip 60 having a rectangular parallelepiped shape, a first external electrode 40a provided on a first edge face of the multilayer chip 60, and a second external electrode 40b provided on a second edge face facing with the first edge face. In the following description, the same numeral is added to each member that is the same as that of the all solid battery 100. And, a detail explanation of the same member is omitted.

In the all solid battery 100a, each of the first electric collector layers 12 and each of the second electric collector layers 22 are alternately stacked. Edges of the first electric collector layers 12 are exposed to the first edge face of the multilayer chip 60 but are not exposed to the second edge face of the multilayer chip 60. Edges of the second electric collector layers 22 are exposed to the second edge face of the multilayer chip 60 but are not exposed to the first edge face. Thus, each of the first electric collector layers 12 and each of the second electric collector layers 22 are alternately conducted to the first external electrode 40a and the second external electrode 40b.

The first electrode layer 11 is stacked on the first electric collector layer 12. The solid electrolyte layer 30 is stacked on the first electrode layer 11. The solid electrolyte layer 30 extends from the first external electrode 40a to the second external electrode 40b. The second electrode layer 21 is stacked on the solid electrolyte layer 30. The second electric collector layer 22 is stacked on the second electrode layer 21. Another second electrode layer 21 is stacked on the second electric collector layer 22. Another solid electrolyte layer 30 is stacked on the second electrode layer 21. The solid electrolyte layer 30 extends from the first external electrode 40a to the second external electrode 40b. The first electrode layer 11 is stacked on the solid electrolyte layer 30. In the all solid battery 100a, the stack units are repeatedly stacked. Therefore, the all solid battery 100a has a structure in which a plurality of cell units are stacked.

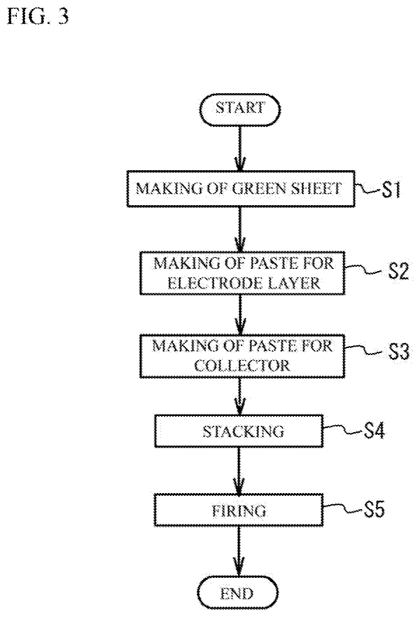

FIG. 3 illustrates a flowchart of the manufacturing method of the all solid battery 100 and the all solid battery 100a.

(Making process of green sheet) Powder of the oxide-based solid electrolyte structuring the solid electrolyte layer 30 is made. For example, it is possible to make the powder of the oxide-based solid electrolyte structuring the solid electrolyte layer 30, by mixing raw material and additives and using solid phase synthesis method or the like. The resulting powder is subjected to dry grinding. Thus, a grain diameter of the resulting power is adjusted to a desired one. For example, the grain diameter of the resulting power is adjusted to a desired one by a planetary ball mil using ZrO₂ balls having a diameter of 5 mm φ.

The resulting powder is evenly dispersed into aqueous solvent or organic solvent together with a binding agent, a dispersing agent, a plasticizer and so on. The resulting power is subjected wet crushing. And solid electrolyte slurry having a desired grain diameter is obtained. In this case, a bead mill, a wet jet mill, a kneader, a high pressure homogenizer or the like may be used. It is preferable that the bead mill is used because adjusting of particle size distribution and dispersion are performed at the same time. A binder is added to the resulting solid electrolyte slurry. Thus, solid electrolyte paste is obtained. The solid electrolyte paste is coated. Thus, a green sheet is obtained. The coating method is not limited. For example, a slot die method, a reverse coat method, a gravure coat method, a bar coat method, a doctor blade method or the like may be used. It is possible to measure grain diameter distribution after the wet crushing, with use of a laser diffraction measuring device using a laser diffraction scattering method.

(Making process of paste for electrode layer) Next, paste for electrode layer is made in order to make the first electrode layer 11 and the second electrode layer 21. For example, a conductive auxiliary agent, an active material, a solid electrolyte material, a binder, a plasticizer and so on are evenly dispersed into water or organic solvent. Thus, paste for electrode layer is obtained. For example, it is possible to use a mixing method of thick kneading, a kneading method using a planetary mixer, a high shear mixer, a paste kneading or a filmix, or a known paste making method. The above-mentioned solid electrolyte paste may be used as the solid electrolyte material. Carbon materials can be used as the conductive auxiliary agent. When the composition of the first electrode layer 11 is different from that of the second electrode layer 21, paste for electrode layer used for the first electrode layer 11 and another paste for electrode layer used for the second electrode layer 21 may be individually made.

(Making process of paste for electric collector) Next, paste for electric collector is made in order to make the first electric collector layer 12 and the second electric collector layer 22. It is possible to make the paste for electric collector, by evenly dispersing powder of Pd, a binder, dispersant, plasticizer and so on into water or organic solvent.

(Stacking process) The paste for electrode layer and the paste for electric collector are printed on both faces of the green sheet, with respect to the all solid battery 100 described on the basis of FIG. 1. The printing method is not limited. For example, a screen printing method, an intaglio printing method, a letter press printing method, a calendar roll printing method or the like may be used. In order to make a stacked device having a thin layer and a large number of stacked layers, the screen printing is generally used. However, an ink jet printing may be preferable when a micro size electrode pattern or a special shape is necessary. Instead of printing the paste for electrode layer, a green sheet for electrode layer formed by coating the paste for electrode layer on a PET film and drying may be used.

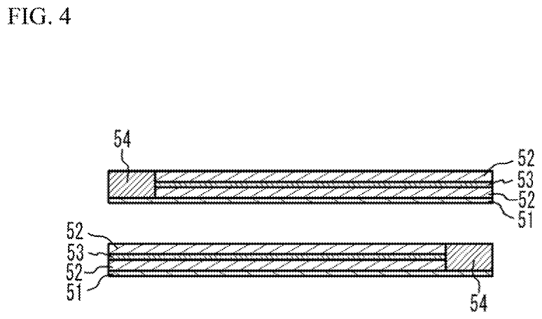

With respect to the all solid battery 100a described on the basis of FIG. 2, paste 52 for electrode layer is printed on one face of a green sheet 51 as illustrated in FIG. 4. Paste 53 for electric collector is printed on the paste 52 for electrode layer. And, another paste 52 for electrode layer is printed on the paste 53 for electric collector. A reverse pattern 54 is printed on a part of the green sheet 51 where neither the paste 52 for electrode layer nor the paste 53 for electric collector is printed. A material of the reverse pattern 54 may be the same as that of the green sheet 51. The green sheets 51 after printing are stacked so that each of the green sheets 51 is alternately shifted to each other. Thus, a multilayer structure is obtained. In this case, in the multilayer structure, a pair of the paste 52 for electrode layer and the paste 53 for electric collector are alternately exposed to the two edge faces of the multilayer structure. For example, a thickness of the multilayer structure is approximately 300 μm.

(Firing process) Next, the resulting multilayer structure is fired. In the firing process, it is preferable that a maximum temperature is 400 degrees C. to 1000 degrees C. in oxidizing atmosphere or non-oxidizing atmosphere. It is more preferable that that maximum temperature is 500 degrees C. to 900 degrees C. In order to sufficiently remove the binder until the maximum temperature, a process for keeping a temperature lower than the maximum temperature in an oxidizing atmosphere may be performed. It is preferable that the firing is performed in the lowest possible temperature, from a viewpoint of reduction of the process cost. After the firing, a re-oxidizing process may be performed. In this manner, the all solid battery 100 or the all solid battery 100a is manufactured. The first external electrode 40a and the second external electrode 40b may be formed by a sputtering method or the like.

When an interaction between materials may be a problem, only the solid electrolyte layer may be sintered in advance and a sintered pellet may be formed. The electrode layers may be formed on both faces of the pellet by printing or coating the paste for electrode layer on both faces of the pellet. After that, if necessary, the electrode layers may be favorably adhered to the solid electrolyte layer by performing thermal treatment at a temperature lower than the firing temperature of the solid electrolyte pellet.

### EXAMPLES

The all solid batteries in accordance with the embodiment were made and the property was measured.

### Example 1

An electrode layer including the positive electrode active material, the conductive auxiliary agent, and the LLTO was formed. LiCoO₂ made by NIPPON CHEMICAL INDUSTRIAL CO., LTD was used as the positive electrode active material. Acetylene black made by DENKA COMPANY LIMITED was used as the conductive auxiliary agent. LLTO made by TOSHIMA MANUFACTURING was used as the LLTO. It was confirmed that the LLTO has a perovskite structure from results of XRD.

LiCoO₂, LLTO, acetylene black and polyvinylidene fluoride (PVdF) were mixed in a mortar with a weight ratio of 40:40:10:10. During the mixing, PVdF and N-methyl-2-pyrrolidinone (NMP) were added little by little. When the mixed materials were thick-kneaded, the mixed materials were sufficiently kneaded. NMP was further added. And, the kneading was continued until the materials became paste. The paste was sufficiently stirred in a paste stirrer. The paste was coated on an aluminum foil by a doctor blade method. After the coating, the paste was dried on a hot plate at 100 degrees C. After that, the paste was heated and pressed by a roll press machine. Thus, a density of an electrode was increased. After that, the electrode was stamped into Φ15 mm. Thereby, an electrode layer was formed.

The electrode was sealed in a 2032 type coin cell in which the electrode sandwiched a paper separator of Φ16.5 mm with a metal Li foil of Φ 15 mm was provided, in Ar atmosphere. The coin cell was used as a half cell. Positive electrode characteristic of the half cell was evaluated by a cyclic voltammetry. At 25 degrees C., a voltage was swept in a range of 3.0 V to 4.2 V vs Li/Li⁺ with a sweeping speed of 0.1 mV/sec. As a result, LiCoO₂ had a characteristic oxidation-reduction peak around 4 V. Other electrochemical reactions were not observed.

### Example 2

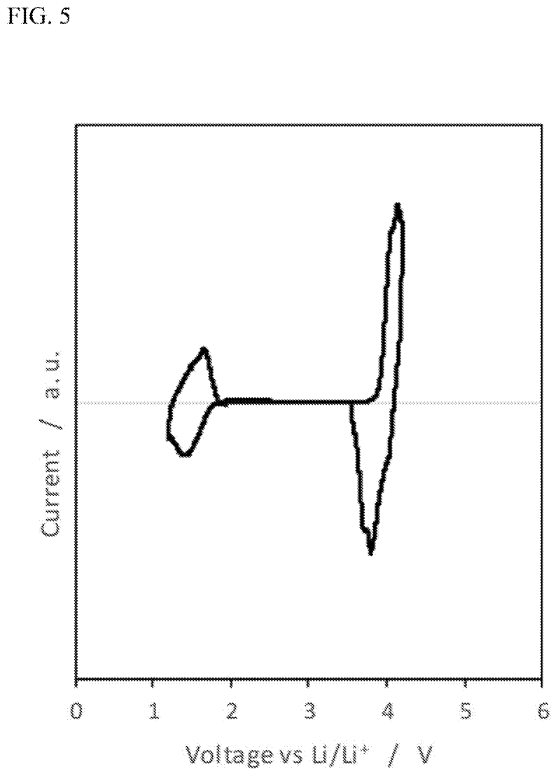

Negative electrode characteristic of the half cell which was made in the example 1 and was subjected to the CV evaluation was evaluated by sweeping the voltage to 1.2 V with a sweeping speed of 0.1 mV/sec at 25 degrees C. and returning the voltage to 3 V with the same sweeping speed. As a result, a peak which may be caused by the oxidation-reduction of the LLTO was observed around 1.6 vs Li/Li⁺. Other electrochemical reactions were not observed. FIG. 5 illustrates the CV evaluation result (cyclic voltammogram) of the examples 1 and 2.

### Example 3

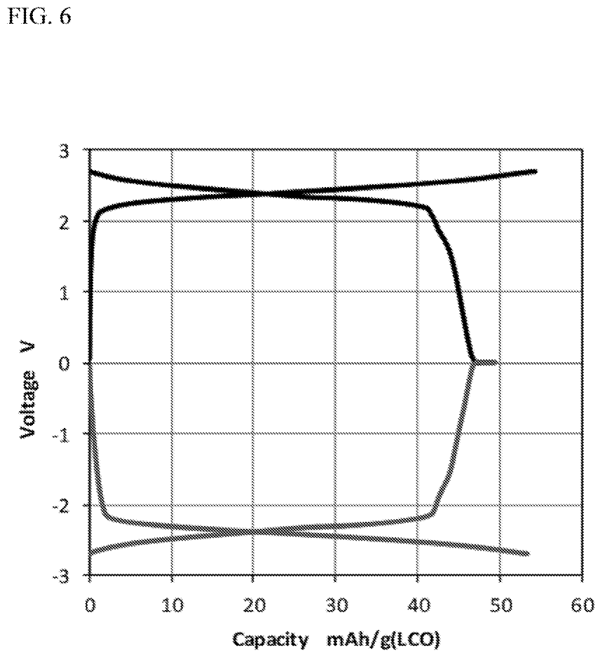

Electrodes were made by the same method as the example 1. The electrodes were sealed in a 2032 type coin cell in Ar atmosphere. In the coin cell, the electrodes faced with each other and sandwiched a paper separator. The coin cell was used as a full cell. Battery characteristic of the full cell was evaluated by a constant current discharge-charge measurement. At 25 degrees C., the full cell was charged to +2.7 V with a current value of 13.3 mA/g (LCO). After that, the full cell was discharged to 0 V with the same current value. And, 0 V was kept for three hours. In this manner, CCCV discharged was performed. Next, the full cell was discharged to −2.7 V. And, the CCCV discharge was performed to 0 V. The discharge-charge curve was illustrated in FIG. 6. A potential terrace which was approximately the same as the oxidation-reduction potential difference between LiCoO₂ and the LLTO in the cyclic voltammogram of FIG. 5 was observed around 2.3 V to 2.4 V. And, the capacity was approximately 45 mAh/g (LCO standard). In the voltage range of minus side, a similar oxidation-reduction peak was observed around −2.3V. The discharge-charge curve of the plus side was approximately symmetrical with that of the minus side. From the result, it is understood that a symmetric type battery performs both the positive electrode reaction and the negative electrode reaction even if the voltage was swept to whichever side. It is thought that the battery has high resistance to excessive discharge because the symmetric type battery is not broken even if the voltage is swept to the minus side.

### Example 4

Li₇La₃Zr₂O₁₂ (LLZO) made by TOSHIMA MANUFACTURING was used as the solid electrolyte. The solid electrolyte was kneaded with a binder and granulated. And pellets having a thickness of 300 μm were made by putting the solid electrolyte and the binder in a metal mold and press-molding the solid electrolyte and the binder by a single axis press machine. The pellets were buried in LLZO powder of the same composition in normal atmosphere at 1300 degrees C. and were fired for five hours. Thus, sintered pellets of the solid electrolyte were made. The sintered pellets were grinded and smoothed by a water proof abrasive paper #2000. After that, the weight ratio of LiCoO₂, LLTO, acetylene black and ethyl cellulose was 25:55:10:10. Terpineol was used as diluent solvent. Other conditions were the same as those of the example 1. Thus, paste for electrode layer including the LiCoO₂, the LLTO and the acetylene black was made. The paste for electrode layer was printed on the upper face and the lower face of the sintered pellets. Thereby, electrode layers were formed. After that, the pellets were fired in inert gas atmosphere. The firing temperature was 600 degrees C., 700 degrees C. and 800 degrees C. An electric collector layer was formed on each of the upper face and the lower face of the fired pellets by an Au sputtering. Thus, all solid batteries were made. Each of the all solid batteries was sealed in a 2032 type coin cell in Ar atmosphere. Thus, the coin cells were used as full cells. The cyclic voltammetry was performed at 150 degrees C. As well as electrolyte solution-based full cell, oxidation-reduction peaks were observed around 2.3 V and −2.3 V. The discharge capacity was approximately 11 μAh/cm²·μm in plus side and minus side. The all solid batteries made under the above-mentioned condition had high symmetrical characteristic, as well as the electrolyte solution-based full cell. And, the all solid batteries operated stably at high temperature of 150 degrees C. at which the electrolyte solution-based battery of the examples 1 to 3 did not operate. When the batteries are downsized, the batteries may be applied to an accumulation device which has high stability at a reflow temperature or under a high temperature usage condition and can be surface-mounted. It is thought that the devices of no polarity type are favorably used without identifying polarity.

From the results of the examples 1 to 4, it is understood that a symmetrical all solid battery is achieved, only the positive electrode active material acts in the positive electrode in accordance with the applied voltage, and only the LLTO acts in the negative electrode in accordance with the applied voltage, when the positive electrode active material and the LLTO are added to the both electrode layers.

Although the embodiments of the present invention have been described in detail, it is to be understood that the various change, substitutions, and alterations could be made hereto without departing from the spirit and scope of the invention.

What is claimed is:

1. An all solid battery comprising:
a first electrode layer that includes a positive electrode active material and a Li—La—Ti—O-based oxide;
a second electrode layer that includes a positive electrode active material and a Li—La—Ti—O-based oxide; and
a solid electrolyte layer that includes an oxide-based solid electrolyte and is sandwiched by the first electrode layer and the second electrode layer.

2. The all solid battery as claimed in claim 1, wherein the positive electrode active material of the first electrode layer and the second electrode layer is LiCoO₂.

3. The all solid battery as claimed in claim 1, wherein the oxide-based solid electrolyte has a NASICON structure.

4. The all solid battery as claimed in claim 1, wherein the solid electrolyte layer includes a Li—La—Zr—O-based oxide.

5. The all solid battery as claimed in claim 1, wherein the first electrode layer and the second electrode layer include a common component.

6. The all solid battery as claimed in claim 1, wherein the first electrode layer and the second electrode layer include a different component.
